(19) United States
(12) Patent Application Publication
(10) Pub. No.: US 2007/0169015 A1
(43) Pub. Date: Jul. 19, 2007

(54) Web services development automation toolkit with test case driver and customized configuration file

(75) Inventors: Michael J. Seelig, Berkeley, CA (US); Seth G. Merriman, Walnut Creek, CA (US); Bilal Muzaffar, Dublin, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/297,800

(22) Filed: Dec. 7, 2005

(51) Int. Cl. G06F 9/45; G06F 9/44

(52) U.S. Cl. 717/136; 717/101

(57) ABSTRACT

Based on information specific to a company, a customized Web services development tool kit is automatically generated. The customized Web services development tool kit comprises at least one configuration file customized to the company based on the information, and a Web services test case driver. The customized Web services development tool kit may be used to develop, for the company, a client interface to a Web services system and to test the client interface using the Web services test case driver and the at least one configuration file.

### FIELD OF THE DISCLOSURE

The present disclosure is generally related to software development kits.

### BACKGROUND

In business-to-business (B2B) and other applications, software developers interpret published development specifications associated with a Web services system to develop and maintain client interfaces to work with the Web services system.

### BRIEF DESCRIPTION OF THE DRAWINGS

FIG. 1 is a block diagram of an embodiment of client interfaces that interact with a Web services system;

FIG. 2 is a block diagram of an embodiment of Web services development tools to assist in developing the client interfaces;

FIG. 3 is a flow chart of an embodiment of a method of using the Web services development tools;

FIG. 4 is a ladder diagram of an embodiment of a method of testing using a Web services API driver;

FIGS. 5a-5b are an example of a configuration file customized for a developer;

FIG. 6 is an example of code to invoke a bind;

FIG. 7 is a block diagram illustrating various components used in testing; and

FIG. 8 is a block diagram of an illustrative embodiment of a general computer system.

### DETAILED DESCRIPTION OF THE DRAWINGS

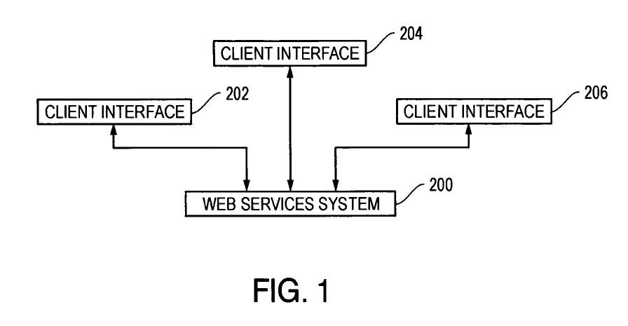

Disclosed herein are embodiments of a Web services development tool kit that comprises Web services development tools. One or more of the tools are customized for a particular company that is to develop a client interface to Web services. The Web services development tools provide a common development programming language framework to streamline and automate activities required to use a Web services interface such as a Simple Object Access Protocol (SOAP) Web services interface. The Web services development automation tools provide a suite of development utilities, executables, configuration files, SOAP clients, test data for internal or external company users of a single or multiple Application Program Interface (API) transaction services, and optionally other ready-to-use computer program code. By using the development tools, internal and external business-to-business (B2B) users of a Web services system 200 shown in FIG. 1 can save time and expenses for initial set-up and ongoing maintenance of their client interfaces 202, 204 and 206 versus a typical manual method of interpreting published development specifications. The tool kit may be generated and provided by a company to enable others to sell the company's products and services using the company's Web services system 200. The client interfaces 202, 204 and 206 may be created by other companies to sell the products and services using the Web services system 200.

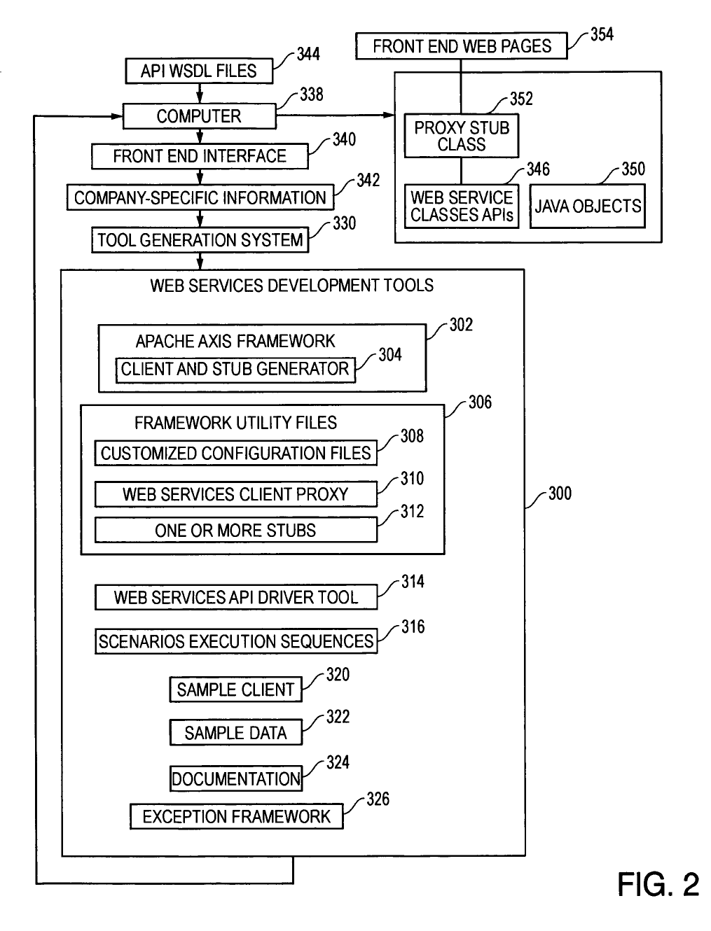

FIG. 2 is a block diagram of an embodiment of Web services development tools 300 to assist in developing the client interfaces 202, 204 and 206. In this embodiment, the Web services development tools 300 include: an Apache Axis framework 302 or another SOAP-based framework that includes a client and stub generator 304. Further, the Web services development tools 300 include one or more framework utility files 306 that include one or more customized configuration files 308, a Web services client proxy 310, and one or more stubs 312. As shown, the Web services development tools 300 can include a Web services API driver 314 (also referred to as a test case driver) and one or more scenarios execution sequences 316. Also, the Web services development tools 300 can include a sample client 320, sample data 322, documentation 324, and an exception framework 326. In a particular embodiment, use of these items can reduce or eliminate many recurring coding and unit testing tasks of a developer of a client interface.

In an exemplary, non-limited, embodiment, a tool generation system 330 can customize one or more of the Web services development tools 300 to each company that is to have a client interface that accesses the Web services system 200. For example, the tool generation system 330 can generate and provide a first configuration file specific to a first company/developer, and a second configuration file specific to a second company/developer, where the first configuration file differs from the second configuration file. As another example, the tool generation system 330 can generate different scenario execution sequences for different developers/companies.

Further, the tool generation system 330 can modify or otherwise refresh the Web services development tools 300 over time for each company/developer. The Web services development tools 300 can be refreshed based on updated product and service information for the company.

After the various components have been generated, the tool generation system 330 can aggregate and/or compress either some or all of the Web services development tools 300 into one or more files such as ZIP file(s). In an embodiment, the Web services development tools 300 are embodied as a kit that is accessible by selecting one or more links at a Web site.

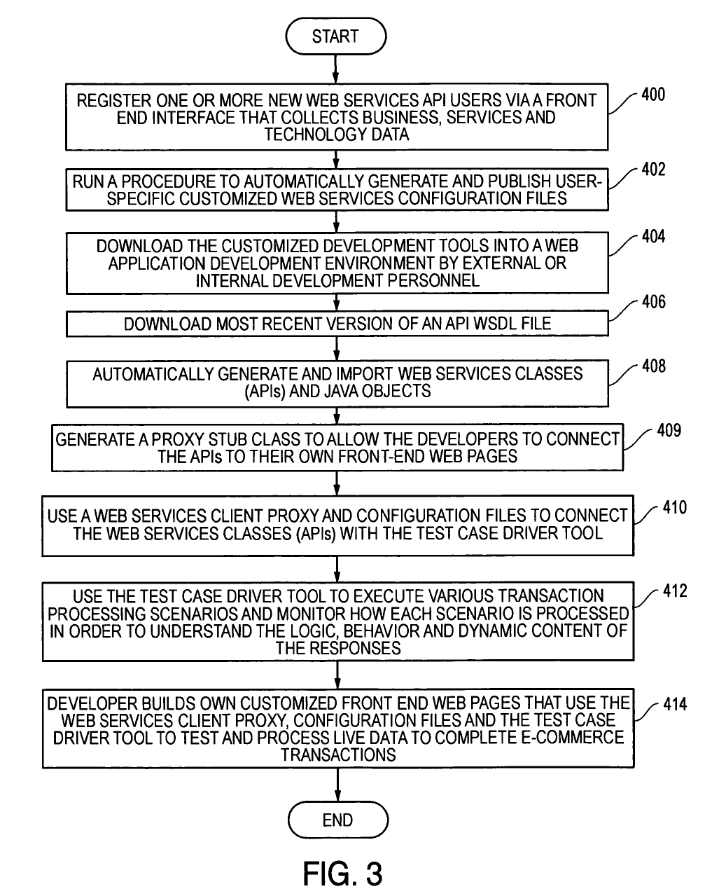

FIG. 3 is a flow chart of an embodiment of a method of using the Web services development tools 300. Although described with reference to a single company and its software developer, the method is usable for customizing the Web services development tools 300 for each of a plurality of companies and developers. For ease of discussion, acts described with reference to FIG. 3 also make reference to elements of FIG. 2.

Commencing at block 400, a Web services API developer is registered via a front-end interface 340 using a computer 338. The front-end interface 340 collects company-specific information 342 such as business, services, and technology data. The information can be received from the computer 338 or other sources. The developer may comprise either external or internal development personnel.

Proceeding to block 402, the tool generation system 330 runs a stored procedure to automatically generate and publish the one or more company-specific customized Web services configuration files 308 based on the company-specific information 342. Examples of the program code features of the configuration files 308 that can be customized include, but not are limited to, user names and passwords, service listings, promotion codes, and Web services endpoints. The configuration files 308 drive configurable runtime inputs such as a default key store directory path, a key store password, and an endpoint Uniform Resource Locator (URL) of services. The scenarios execution sequences 316 also can be generated specific to the company, e.g. based on which products and services the company is to offer.

As indicated by block 404, the developer downloads the Web services development tools 300 that were customized for the company to the computer 338. The customized Web services development tools 300 can be downloaded into a Web application development environment for the developer. Examples of the Web application development environment include a Websphere Application Development (WSAD) project or another project.

Moving to block 406, the developer downloads a most current version of one or more API Web Services Description Language (WSDL) file(s) 344 to the computer 338. At block 408, the developer uses a SOAP framework such as the Apache Axis framework 302 and the framework utility files 306 with the WSDL file(s) 344 to automatically generate and import one or more Web services classes (APIs) 346 and Java objects 350 using the computer 338. A proxy stub class 352, which allows the developer to connect the APIs 346 to its own front-end Web pages 354, is also generated using the computer 338 as indicated by block 409. The proxy stub class 352 mitigates a burden of communicating with Web services at a SOAP level and allows external partners to invoke Web services methods in any development environment that supports SOAP and Web service proxies.

Further, at block 410, the developer uses the Web services client proxy 310 and the configuration files 308 to connect the Web services classes (APIs) 346 with the Web services API driver 314. If a public key identifier (PKI) digital ID (e.g. a client certificate) is required to access the Web services API, then the developer should have installed a signed PKI and private key into its key store using a Java keytool or similar tool. The act indicated by block 410 may include installing or validating that the testing configuration file is mapped to the client proxy 310, and executing the Web services API driver 314 to confirm that the PKI and test configuration files were installed properly.

Moving to block 412, the developer uses the Web services API driver 314 to execute various transaction processing scenarios and monitor how each scenario is processed in order to understand the logic, behavior, and dynamic content of the responses. At block 414, the developer builds one or more customized front-end Web pages that use the Web services client proxy 310, the configuration files 308 and the Web services API driver 314 to test and process live data to complete e-commerce transactions.

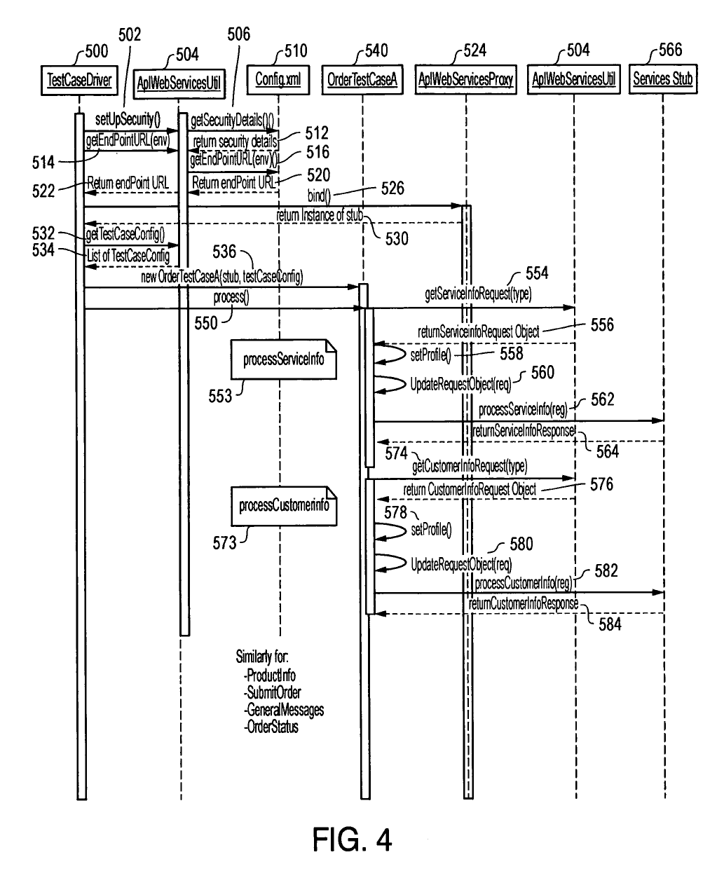

FIG. 4 is a flow diagram of an embodiment of a method of testing using the Web services API driver 314 to execute various transaction processing scenarios. The Web services API driver 314 comprises a test case driver 500 (e.g. TestCaseDriver.java). The test case driver 500 is a main driver class which uses helper classes, and instantiates and executes configured test case classes.

At step 502, the test case driver 500 invokes a set-up-security method (e.g. setUpSecurity( )) of a Web services utility 504. At step 506, the Web services utility 504 reads a configuration file 510 (e.g. config.xml) to get security details.

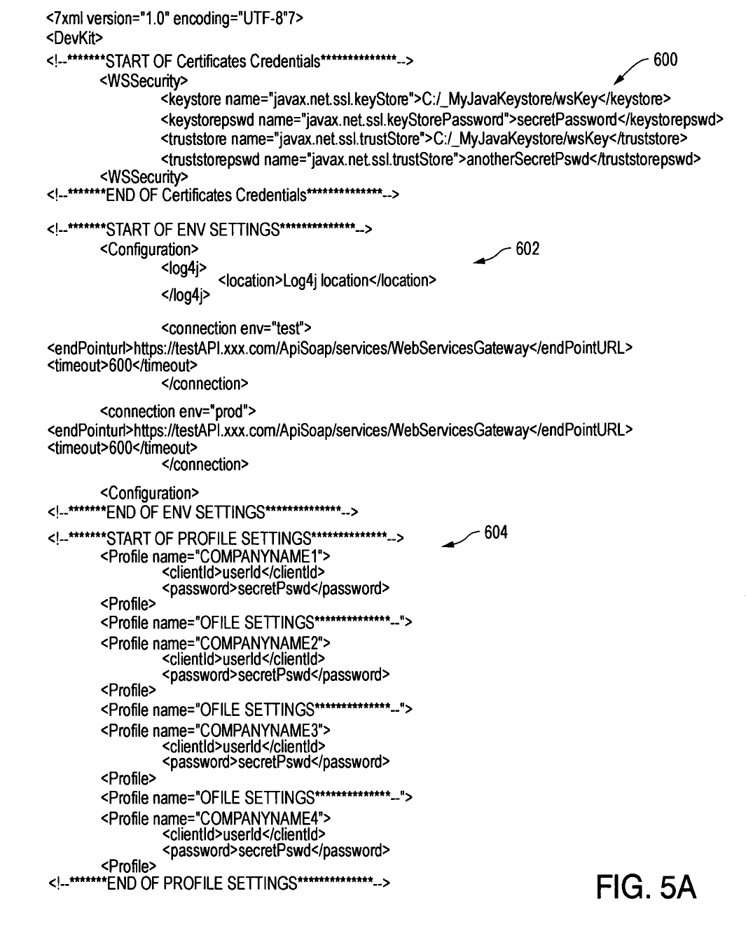

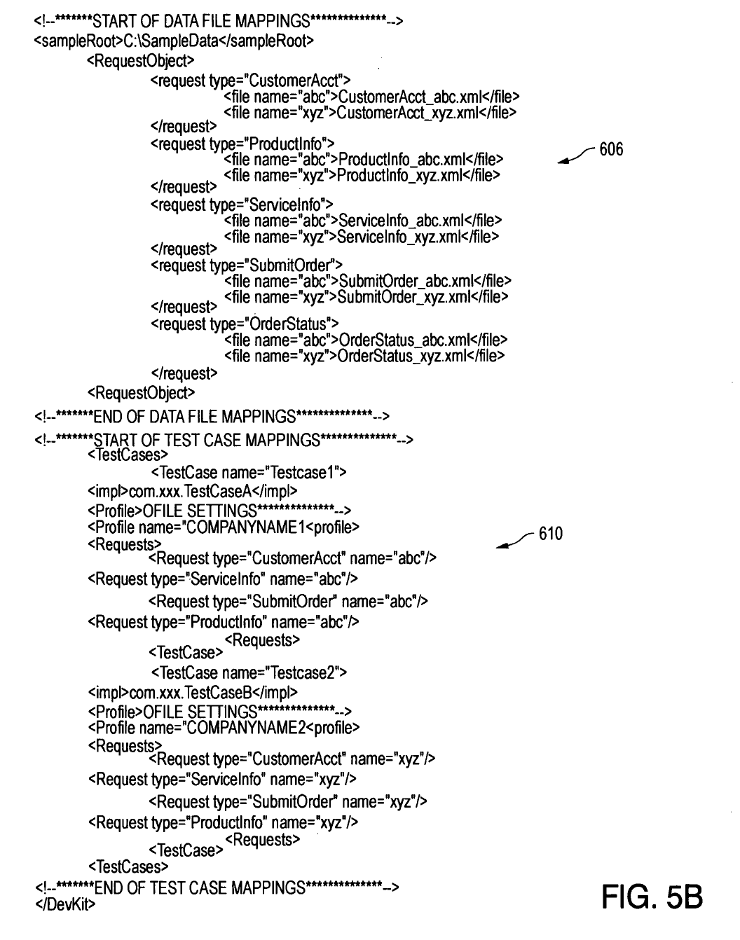

An example of the configuration file 510 is shown in FIGS. 5a-5b. The configuration file comprises respective computer program code portions for each of certification credentials 600, environment settings 602, profile settings 604, data file mappings 606, and test case mappings 610. Some or all of the respective computer program code portions are customized to the particular company/developer by the tool generation system 330.

Referring back to FIG. 4, at step 512, the security details from the configuration file 510 are returned to the Web services utility 504. The Web services utility 504 parses the configuration file 510 and retrieves a key store value (e.g. keyStore), a key store password value (e.g. keyStorePassword), a trust store value (e.g. trustStore), a trust store password value (e.g. trustStorePassword), and/or other security details. The Web services utility 504 sets these values in class variables.

In an embodiment, the set-up security method gets a WSSecurity object from the configuration file 510, retrieves the values for keyStore, KeyStorePassword, trustStore, trustStorePassword and endPointURL therefrom, and sets system properties based on the values. An example of setting the system properties is as follows:

System.setProperty( KEYSTORE, WSSecurity.geKeyStore( )); // “javax.net.ss1.keyStore”, “C:/₁₃ MyJavaKeystore/KS1”);

System.setProperty(KEYSTORE_PASSWORD, WSSecurity.getKeyStorePassword( )); // “javax.net.ss1.keyStorePassword”

System.setProperty(TRUSTSTORE, WSSecurity.getTrustStore( )”);

System.setProperty(“javax.net.ss1.trustStorePassword”, “kspassword”); // Use Sun's reference implementation of a URL handler for the “https” URL protocol type

System.setProperty(“java.protocol.handler.pkgs”,“com.sun.net.ss1.internal.ww w.protocol”);

System.setProperty(“javax.net.debug”, “ssl”); //all/ss1//Dynamically register SUN's ss1 providerjava.security.Security.addProvider(new com.sun.net.ss1.internal.ss1.Provider( )).

At steps 514 and 516, the test case driver 500 invokes an endpoint Uniform Resource Locator (URL) method (e.g. endPointUrl=WebServicesUtil.getEndPointURL(env)) to retrieve an endpoint URL address depending on a set environment. Moreover, at steps 520 and 522, the endpoint URL address is returned from the configuration file 510 to the test case driver 500 via the Web services utility 504. In an embodiment, the endpoint URL method returns the endpoint URL address as a string based on an endpoint URL map.

Although not illustrated, the test case driver 500 can invoke a timeout method (e.g. timeout =WebServicesUtil.getTimeoutL(env)) to retrieve a timeout value for a given environment.

The test case driver 500 invokes a Web service proxy method 524 (e.g. WebServiceProxy proxy=new WebServiceProxy( )) to create an instance of a proxy class. The WebServiceProxy class abstracts Axis-related client proxy code that helps in binding to the API Web services. The stub is created during design time using the endpoint URL as an input to bind to a specific server. The Web service proxy method 524 initializes a service locator.

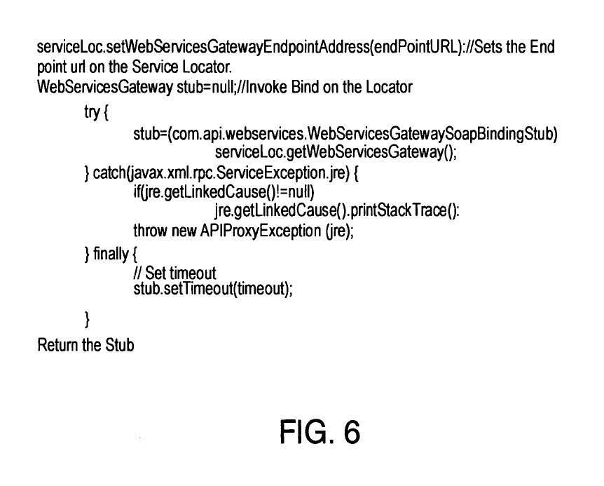

Proceeding to step 526, the test case driver 500 invokes a method to bind a stub to the endpoint URL address (e.g. WebServicesGateway stub=proxy.bind(endPointUrl)). The bind( ) method can set the endpoint URL on a service locator, invoke a bind on the locator, set a timeout value and return a stub. An example of computer program code to invoke the bind is shown in FIG. 6. Briefly, the computer program code in FIG. 6 acts to attempt to set up a SOAP connection, throw an exception if the attempt is unsuccessful, and set a timeout if the connection is made. At step 530, an instance of the stub is returned to the test case driver 500.

Moving to step 532, the test case driver 500 invokes a method to retrieve all test case scenarios required to be run (e.g. testCaseConfigList=WebServicesUtil.getTestCases( )). At step 534, a list of test case scenarios is returned to the test case driver 500. The testCaseConfigList is determined by parsing the configuration file 510.

Further, at step 536, the test case driver 500 iterates through the list of test case scenarios and instantiate each class. For example, consider the test case driver 500 instantiating a first order test case 540, which is a constructor method, based on a WebServicesGateway value and a testCaseConfig value.

A Java class for the test case is created (e.g. TestCase testcase=Class.forName(testCaseConfig.getTestCaseImpl( ))). The configuration is read for the class (e.g. testcase.setTestCaseConfig (testCaseConfig)). The text case is executed (e.g. testcase.process( )). The process internally calls the required methods. This method retrieves which profile to be used and which data file to be selected.

Continuing to step 550, the test case driver 500 invokes a process method (e.g. process( )). The process method, in turn, calls the various methods for one or more invoking Web service APIs via the Web service utility 504. The process method causes retrieval of a Web service gateway bind stub from a test case configuration object, retrieval of a data file path for each of the methods and set in the class variables, and invocation of one or more methods in a particular sequence.

In a particular embodiment, the sequence of methods may comprise methods to process service information 553 in the configuration file 510. The methods to process the service information 553 may comprise a get service information request method (step 554) to which a service information request object is returned (step 556) by the Web service utility 504, a set profile method (step 558), an update request object method (step 560), and a process service information method (step 562) to which a service information response is returned (step 564) by a services stub 566.

Further, in a particular embodiment, the sequence of methods may comprise methods to process customer information 573 in the configuration file 510. The methods to process the customer information 573 may comprise a get customer information request method (step 574) to which a customer information request object is returned (step 576) by the Web service utility 504, a set profile method (step 578), an update request object method (step 580), and a process customer information method (step 582) to which a customer information response is returned (step 584) by the services stub 566.

Similar methods are invoked for product information, order submission, general messages, and order status sequences based on the configuration file 510. The responses generated for each sequence are compared to their expected responses to validate the client interface. Specific examples of requests and expected responses that are used in the validation include, but are not limited to, a customer account information request and response, a product catalog request and response, a customer validation request and response, a service qualification request and response, a future availability request and response, a product details request and response, a product configuration request and response, an order status request and response, a service scheduling request and response, a validate order request and response, a process order request and response, and a process message request and response.

Each of the aforementioned get request methods (e.g. steps 554 and 574) can be implemented using a single get API request object method (e.g. getAPIRequestObj(type)). The type value is a string indicating the type of request to be made. The method is called from the main client program. The method returns an API request object after loading the data from a configuration file, which may be in an extensible markup language (XML). An embodiment of the method performs acts of obtaining a path to the XML file for the given type of request object, reading sample data from the XML file from the path, using Java Architecture for XML Binding (JAXB) to bring together the data in a Java request object, populating the APIRequest object used by Axis from JAXB Java Objects, and returning the APIRequest object.

Either TCPTunnelGUI or UtilSnoop functionality can be mimicked for capturing raw XML requests and responses. UtilSnoop can be modified as required.

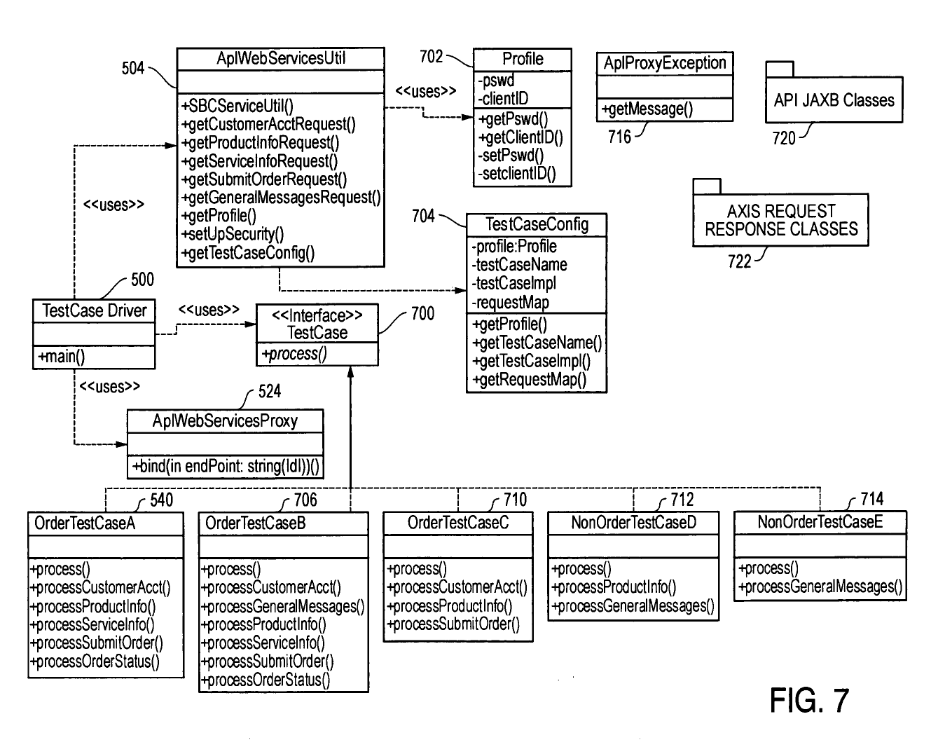

FIG. 7 is a block diagram illustrating various components used in testing. The test case driver 500 uses the Web services utility 504, the Web services proxy 524, and a test case interface 700. The Web services utility 504 uses a profile object 702 to get and set a client identifier and a password. The Web services utility uses a test case configuration object 704 to get a profile, get a test case name, get a test case implication, and get a request map.

In a particular embodiment, the test case interface 700 provides ordering and non-ordering test cases. For purposes of illustration and example, the first ordering test cases comprise the order test case 540, a second order test case 706, and a third order test case 710. In an exemplary, non limited embodiment, the first order test case 540 is used to test a customer account feature, a product information feature, a service information feature, an order submission feature, and an order status feature. In addition to the aforementioned features, the second order test case 706 is used to test a general messages feature. Also, the third order test case 710 is used to test a customer account feature, a product information feature, and an order submission feature.

For purposes of illustration and example, the non-ordering test cases comprise two non-order test cases 712 and 714. In an exemplary, non-limited embodiment, the first non-order test case 712 is used to test a product information feature and a general messages feature. Moreover, the second non-order test case 714 is used to test a general messages feature.

An API proxy exception 716 is part of the exception framework 326 (FIG. 2). The exception framework 326 (FIG. 2) comprises a base interface that custom exceptions are to implement. The base interface enforces standard implementations for retrieving information from an exception. A proxy layer catches all SOAP exceptions and builds a service extension. The service exception extends a base exception class and contains error information related to a specific API. The service exception encapsulates exceptions thrown by utility methods (e.g. set key store path, set endpoint URL and set key store password) before being sent to the client layer. The exception framework 326 (FIG. 2) can provide the following hierarchy of exceptions: (1) service extensions containing a SOAP exception, (2) service exceptions containing a ROOT exception, and (3) other service exceptions.

API JAXB classes 720 and Axis Request Response classes 722 are separate packages that are referenced by elements in FIG. 7. The API JAXB classes 720 are used to transform configuration files to Java objects. Axis is used to generate stub and client codes along with all necessary request and response objects for API transactions.

Referring back to FIG. 2, the tool generation system 330 can provide different tools for different developers, different external companies, and/or different programming languages. Some embodiments of the tools 300 can include the different WSDL files for APIs, remote SOAP proxy classes, request and response objects, configuration files and documentation. In a C++ language, the tools 300 may exclude compiled class files because C++ compiled files are environment-specific. In a Microsoft .NET Framework, the tools 300 may comprises a utility that is used to generate a Web service proxy for use in the .NET Framework development environment, and to create a client proxy in all .NET languages (e.g. C# and Visual BASIC .NET).

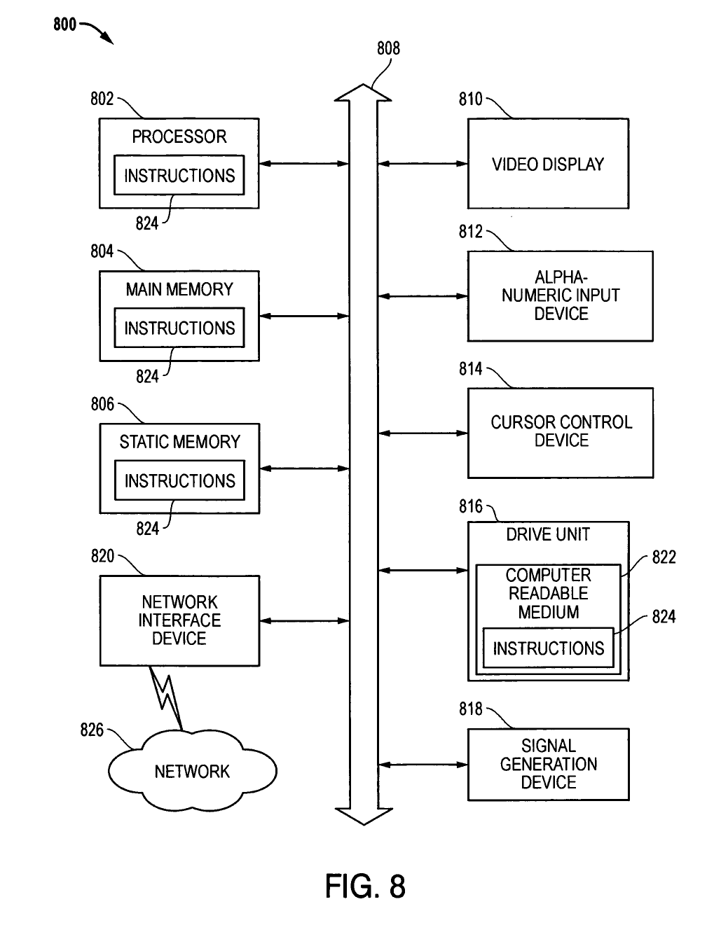

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a tool generator responsive to first information specific to a first company, the tool generator to automatically generate a first customized Web services development tool kit based on the first information, the first customized Web services development tool kit usable to develop for the first company a first client interface to a Web services system, the first customized Web services development tool kit comprising a first at least one configuration file customized based on the first information, and a Web services test case driver to test the first client interface based on the first at least one configuration file.

2. The system of claim 1, wherein the first customized Web services development tool kit is generated for a first software developer, wherein the tool generator is responsive to second information specific to a second company, wherein the tool generator is to automatically generate a second customized Web services development tool kit for a second software developer based on the second information, the second customized Web services development tool kit usable by the second software developer to develop for the second company a second client interface to the Web services system, the second customized Web services development tool kit comprising a second at least one configuration file customized based on the second information, and the Web services test case driver to test the second client interface based on the second at least one configuration file.

3. The system of claim 2, wherein the first information differs from the second information, and wherein the first at least one configuration file differs from the second at least one configuration file.

4. The system of claim 1, wherein the tool generator is to automatically customize computer program code for one or more certification credentials based on the first information, and include the computer program code in the first customized Web services development tool kit.

5. The system of claim 1, wherein the tool generator is to automatically customize computer program code for environment settings based on the first information, and include the computer program code in the first customized Web services development tool kit.

6. The system of claim 1, wherein the tool generator is to automatically customize computer program code for one or more profile settings based on the first information, and include the computer program code in the first customized Web services development tool kit.

7. The system of claim 1, wherein the tool generator is to automatically customize computer program code for one or more data file mappings based on the first information, and include the computer program code in the first customized Web services development tool kit.

8. The system of claim 1, wherein the tool generator is to automatically customize computer program code for one or more test case mappings based on the first information, and include the computer program code in the first customized Web services development tool kit.

9. The system of claim 1, wherein the first customized Web services development tool kit further comprises a Web services client proxy and one or more stubs.

10. The system of claim 1, wherein the first customized Web services development tool kit further comprises a client and stub generator.

11. The system of claim 1, wherein the first customized Web services development tool kit further comprises at least one scenario execution sequence.

12. The system of claim 1, wherein the first at least one configuration file is customized for a particular user name and a particular password.

13. The system of claim 1, wherein the first at least one configuration file is customized for a particular service listing.

14. The system of claim 1, wherein the first at least one configuration file is customized for a particular promotion code.

15. The system of claim 1, wherein the first at least one configuration file is customized for a particular Web services end point.

16. A method comprising:
receiving information specific to a company;
automatically generating a customized Web services development tool kit based on the information, the customized Web services development tool kit comprising at least one configuration file customized based on the information, and a Web services test case driver; and
using the customized Web services development tool kit to develop for the company a client interface to a Web services system, and to test the client interface using the Web services test case driver and the at least one configuration file.

17. The method of claim 16, wherein said using the customized Web services development tool kit comprises:
generating one or more Web services classes;
generating a proxy stub class to connect the one or more Web services classes to the client interface;
using a Web services client proxy and the at least one configuration file to connect the one or more Web services classes with the Web services test case driver; and
using the Web services test case driver to execute one or more transaction processing scenarios for the client interface.

18. The method of claim 16, wherein said using the customized Web services development tool kit further comprises:
using the Web services client proxy, the Web services test case driver and the at least one configuration file to test and process data to complete an e-commerce transaction using the client interface.

19. A computer-readable medium having computer program code that provides a Web services development tool kit customized for a software developer, the Web services development tool kit comprising at least one customized configuration file that is customized based on company information, the Web services development tool kit further comprising a Web services test case driver and one or more scenario execution sequences.

20. A computer-readable medium of claim 19, wherein the Web services development tool kit further comprises a client and stub generator, a Web services client proxy, one or more stubs, and a sample client.
